(19) United States
(12) Patent Application Publication
(10) Pub. No.: US 2018/0129058 A1
(43) Pub. Date: May 10, 2018

(54) SYSTEMS, DEVICES, AND METHODS FOR FIELD SHAPING IN WEARABLE HEADS-UP DISPLAY

(71) Applicant: THALMIC LABS INC., Kitchener (CA)

(72) Inventors: Vance R. Morrison, Kitchener (CA); Lloyd Frederick Holland, Kitchener (CA); Ian Andrews, Kitchener (CA); Andrew S. Logan, Waterloo (CA)

(21) Appl. No.: 15/809,629

(22) Filed: Nov. 10, 2017

Related U.S. Application Data
(60) Provisional application No. 62/420,380, filed on Nov. 10, 2016.

(51) Int. Cl. G02B 27/09; G02B 26/08; G02B 5/32; G02B 27/01; G02B 26/10; G02B 27/10

(52) U.S. Cl. CPC G02B 27/0911; G02B 26/0816; G02B 5/32; G02B 27/0172; G02B 2027/0174; G02B 27/104; G02B 2027/0138; G02B 2027/0178; G02B 26/101

(57) ABSTRACT

Systems, devices, and methods for field shaping in wearable heads-up displays (WHUD) with laser projectors are described. A WHUD includes a support structure carrying a laser projector, a field shaper optic, and a transparent combiner to combine the projected laser light and environmental light. The laser projector generates a laser light having a field. The laser light is scanned through the field shaper optic and over the transparent combiner. The field shaper optic heterogeneously varies the focal length of the laser light depending on the laser light properties to alter the field of the laser light to approximately match a shape of the transparent combiner. The transparent combiner redirects the laser light to a field of view of a user to create a focused image at an eye of the user.

### TECHNICAL FIELD

The present systems, devices, and methods generally relate to wearable heads-up displays and particularly relate to field shaping of the laser light output by laser projectors in wearable heads-up displays.

### BACKGROUND

### Description of the Related Art

Laser Projectors

A projector is an optical device that projects or shines a pattern of light onto another object (e.g., onto a surface of another object, such as onto a projection screen) in order to display an image or video on that other object. A projector necessarily includes a light source, and a laser projector is a projector for which the light source comprises at least one laser. The at least one laser is temporally modulated to provide a pattern of laser light and usually at least one controllable mirror is used to spatially distribute the modulated pattern of laser light over a two-dimensional area of another object. The spatial distribution of the modulated pattern of laser light produces an image at or on the other object. In conventional laser projectors, the at least one controllable mirror may include: a single digital micromirror (e.g., a microelectromechanical system (“MEMS”) based digital micromirror) that is controllably rotatable or deformable in two dimensions, or two digital micromirrors that are each controllably rotatable or deformable about a respective dimension, or a digital light processing (“DLP”) chip comprising an array of digital micromirrors.

In a conventional laser projector comprising a RGB laser module with a red laser diode, a green laser diode, and a blue laser diode, each respective laser diode has a corresponding respective focusing lens. The relative positions of the laser diodes, the focusing lenses, and the at least one controllable mirror are all tuned and aligned so that each laser beam impinges on the at least one controllable mirror with substantially the same spot size and with substantially the same rate of convergence (so that all laser beams will continue to have substantially the same spot size as they propagate away from the laser projector towards, e.g., a projection screen). In a conventional laser projector, it is usually possible to come up with such a configuration for all these elements because the overall form factor of the device is not a primary design consideration. However, in applications for which the form factor of the laser projector is an important design element, it can be very challenging to find a configuration for the laser diodes, the focusing lenses, and the at least one controllable mirror that sufficiently aligns the laser beams (at least in terms of spot size, spot position, and rate of convergence) while satisfying the form factor constraints.

Wearable Heads-Up Displays

A head-mounted display is an electronic device that is worn on a user's head and, when so worn, secures at least one electronic display within a viewable field of at least one of the user's eyes, regardless of the position or orientation of the user's head. A wearable heads-up display is a head-mounted display that enables the user to see displayed content but also does not prevent the user from being able to see their external environment. The “display” component of a wearable heads-up display is either transparent or at a periphery of the user's field of view so that it does not completely block the user from being able to see their external environment. Examples of wearable heads-up displays include: the Google Glass®, the Optinvent Ora®, the Epson Moverio®, and the Sony Glasstron®, just to name a few.

### BRIEF SUMMARY

A wearable heads-up display (“WHUD”) may be summarized as including: a support structure that in use is worn on a head of a user; a transparent combiner carried by the support structure, wherein the transparent combiner is positioned within a field of view of an eye of the user when the support structure is worn on the head of the user; a laser projector carried by the support structure, wherein the laser projector is positioned and oriented to scan laser light over at least a first area of the transparent combiner, and wherein laser light output by the laser projector has a focal length; and a field shaper optic positioned in between the laser projector and the transparent combiner in an optical path of the laser light, the field shaper optic to heterogeneously vary the focal length of the laser light to provide an at least approximately uniform laser spot over the first area of the transparent combiner. The support structure may have the shape and appearance of an eyeglasses frame and the transparent combiner may include an eyeglass lens.

The transparent combiner may include at least one holographic optical element positioned to redirect the laser light towards the eye of the user. Upon redirection of the laser light towards the eye of the user, the holographic optical element may at least approximately collimate the laser light to provide a laser spot at the eye of the user having both a size and a shape that at least approximately matches the size and the shape of the laser spot at the transparent combiner.

The laser projector may include: at least one laser diode to generate laser light, and at least one controllable mirror positioned to receive laser light from the laser diode and controllably orientable to scan the laser light over the first area of the transparent combiner. The field shaper optic may be positioned in between the at least one controllable mirror and the transparent combiner in the optical path of the laser light. The laser projector may further comprise: a beam combiner positioned in the optical path of the laser light in between the at least one laser diode and the controllable mirror, wherein the at least one laser diode includes a red laser diode, a green laser diode, and a blue laser diode, and wherein the beam combiner is oriented to combine red laser light from the red laser diode, green laser light from the green laser diode, and blue laser light from the blue laser diode into an aggregate laser beam.

The field shaper optic may be a freeform lens having a shape dependent on both a shape of the transparent combiner and a position of the laser projector in relation to the transparent combiner.

The field shaper optic may be an anamorphic asphere having a shape dependent on both a shape of the transparent combiner and a position of the laser projector in relation to the transparent combiner.

The transparent combiner has a center horizontal axis and a center vertical axis and a position of the laser projector may be off-axis relative to at least one of the center horizontal axis and the center vertical axis of the transparent combiner.

The field shaper optic may heterogeneously vary the focal length of the laser light to provide a laser light field having a shape that at least approximately matches a shape of a surface of the transparent combiner. The transparent combiner may include a curved surface and the field shaper optic may heterogeneously vary the focal length of the laser light to provide a curved laser light field having a curvature that at least approximately matches a curvature of the curved surface of the transparent combiner.

The field shaper optic may heterogeneously vary the focal length of the laser light to achieve an approximately uniform distance of the laser light focal point from the transparent combiner.

To heterogeneously vary the focal length of the laser light the field shaper optic may apply a particular optical function thereto dependent on at least one property of the laser light selected from a group consisting of: a point of incidence of the laser light on the field shaper optic, an angle of incidence of the laser light on the field shaper optic, a spot size of the laser light on the field shaper optic, and a spot shape of the laser light on the field shaper optic.

The laser projector may be positioned and oriented to scan laser light over at least a second area of the transparent combiner, wherein the field shaper optic heterogeneously varies the focal length of the laser light to provide an at least approximately uniform laser spot over the first area and the second area of the transparent combiner. The field shaper optic may be a freeform lens having a shape dependent on both a shape of the transparent combiner and a position of the laser projector in relation to the first area of the transparent combiner and the second area of the transparent combiner. The field shaper lens may include a first anamorphic asphere and a second anamorphic asphere, wherein the first anamorphic asphere heterogeneously varies the focal length of the laser light to provide an at least approximately uniform laser spot over the first area of the transparent combiner and the second anamorphic asphere heterogeneously varies the focal length of the laser light to provide an at least approximately uniform laser spot over the second area of the transparent combiner, and wherein the shape of the first anamorphic asphere is dependent on both a shape of the transparent combiner and a position of the laser projector in relation to the first area of the transparent combiner, and wherein the shape of the second anamorphic asphere is dependent on both a shape of the transparent combiner and a position of the laser projector in relation to the second area of the transparent combiner.

A method of operating a wearable heads-up display, wherein the wearable heads-up display includes a laser projector, a transparent combiner, and a field shaper optic positioned in between the laser projector and the transparent combiner in an optical path of laser light output by the laser projector, may be summarized as including: scanning laser light over at least a first area of the transparent combiner by the laser projector; heterogeneously varying a focal length of the laser light by the field shaper optic to provide an at least approximately uniform laser spot over the first area of the transparent combiner; and redirecting the laser light towards a field of view of an eye of a user of the wearable heads-up display by the transparent combiner. Heterogeneously varying a focal length of the laser light by the field shaper optic to provide an at least approximately uniform laser spot over the first area of the transparent combiner may include heterogeneously varying the focal length of the laser light to provide a laser light field having a shape that at least approximately matches a shape of a surface of the transparent combiner. The transparent combiner may include a curved surface, wherein heterogeneously varying the focal length of the laser light to provide a laser light field having a shape that at least approximately matches a shape of a surface of the transparent combiner includes heterogeneously varying the focal length of the laser light to provide a curved laser light field having a curvature that at least approximately matches a curvature of the curved surface of the transparent combiner.

The transparent combiner may include at least one holographic optical element, wherein redirecting the laser light towards a field of view of an eye of a user of the wearable heads-up display by the transparent combiner includes: collimating, at least approximately, the laser light by the holographic optical element to provide a laser spot at the eye of the user having both a size and a shape that at least approximately match the size and the shape of the laser spot at the transparent combiner.

Heterogeneously varying the focal length of the laser light by the field shaper optic may include heterogeneously varying the focal length of the laser light to achieve an approximately uniform distance of the laser light focal point from the transparent combiner.

Heterogeneously varying a focal length of the laser light by the field shaper optic to provide an at least approximately uniform laser spot over the first area of the transparent combiner may include applying a particular optical function to the laser light dependent on at least one property of the laser light selected from a group consisting of: a point of incidence of the laser light on the field shaper optic, an angle of incidence of the laser light on the field shaper optic, a spot size of the laser light on the field shaper optic, and a spot shape of the laser light on the field shaper optic.

The method may further include: scanning laser light over at least a second area of the transparent combiner by the laser projector; and heterogeneously varying a focal length of the laser light by the field shaper optic to provide an at least approximately uniform laser spot over the second area of the transparent combiner.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1A is a schematic diagram of a wearable heads-up display with a laser projector and a transparent combiner in a field of view of an eye of a user in accordance with the present systems, devices, and methods.

FIG. 1B is a schematic diagram of a wearable heads-up display with a laser projector and a field shaper optic, and a transparent combiner in a field of view of an eye of a user in accordance with the present systems, device and methods.

FIG. 2 is a flow diagram of a method of operating a wearable heads-up display with a laser projector and a field shaper optic in accordance with present systems, devices, and methods.

FIG. 3 is an isometric view of a wearable heads-up display with a laser projector and a field shaper optic in accordance with the present systems, devices, and methods.

FIG. 4 is an isometric view of a wearable heads up display with a laser projector and a field shaper optic which shapes two separate fields in accordance with the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

The various embodiments described herein provide systems, devices, and methods for field shaping and are particularly well-suited for use in wearable heads-up displays.

A “field” of a projection system is the three-dimensional collection of the focal points of the light. That is, if a projector was capable of projecting light in every direction the field would be a sphere with a radius equal to the focal length of the light output by the projector. Therefore, when an image is projected onto a flat surface (e.g. a movie screen), the image is only in focus where the surface is at a distance from the projector that is equal to the focal length of the light. A field flattener lens is a lens that heterogeneously applies optical power to the light to alter the focal lengths of the light so that the collection of focal points is flat (i.e. all focal points reside on a single plane) to match the projection surface. A field flattener lens is most often symmetrical and positioned centrally with respect to the projection surface. In a wearable heads-up display, laser light may be scanned onto a curved surface that is not concentric with the field of the laser light and the projection surface may be in an off-axis location from the projector. A field flattener is not an appropriate optical element to create a focused image on such a surface, rather an optical element that can shape the field of the laser light to match a curved and/or off-axis projection surface is needed. Such an optical element is herein referred to as a “field shaper optic. A field shaper optic may include: a lens (e.g., a freeform optic lens) a liquid crystal optic, a holographic optic (e.g., a transmission hologram), a grating (e.g., as a transmission grating). The field shaper optic may be integrated within other components of the WHUD or laser projector (e.g., a waveguide) or physically coupled to other components of the WHUD or laser projector. The field shaper optic is described in detail below.

Throughout this specification, the result of employing the field shaper optic is to create an “at least approximately uniform” spot size at the transparent combiner. The desired spot shape may be a circle having a diameter of d, wherein the “approximate uniformity” is defined as maintaining a diameter of the spot within 25%, 10%, or 5% of the desired diameter d. The diameter of the spot may not be “directly” measured but may be determined by calculating the full width at half maximum intensity of the laser beam. The spot may also be elliptical wherein approximate uniformity may be defined as maintaining any diameter of the spot within 25%, 10%, or 5% of the largest diameter of the ellipse and/or the smallest diameter of the desired spot size, or as maintaining a vertical diameter and a horizontal diameter of the spot within 25%, 10%, or 5% of the respective vertical and horizontal diameters of the desired spot size. Different areas of the transparent combiner may have different desired spot sizes and/or different measures of uniformity. A person of skill in the art will appreciate that the more stringent the approximate uniformity of the spot size the better the display quality of the WHUD will be as a more uniform spot size can result in increased density of “pixels”.

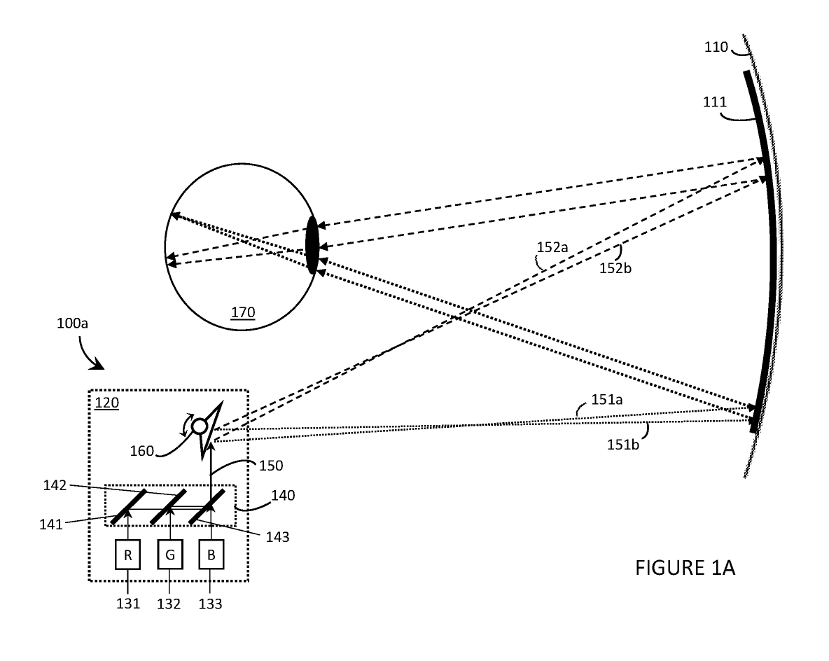

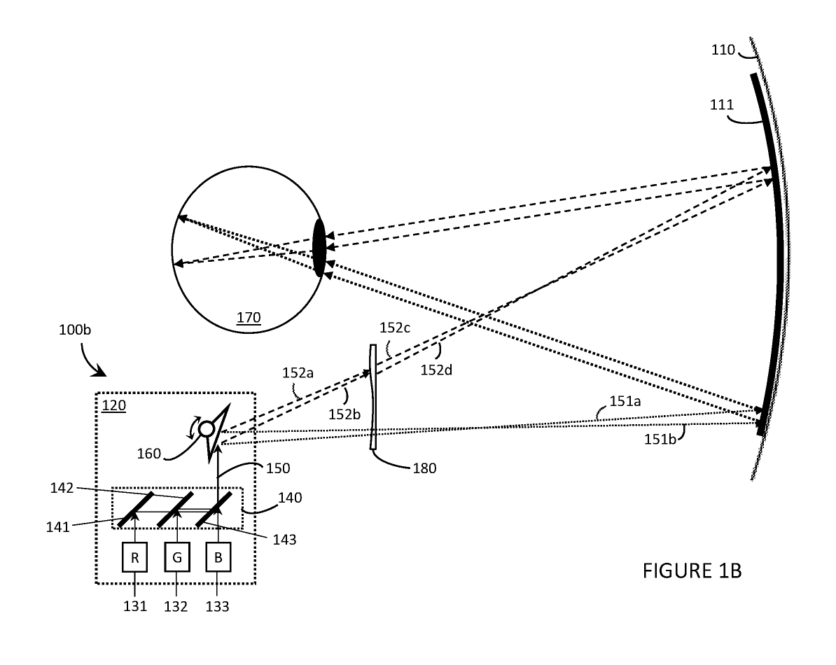

FIG. 1A is a schematic diagram of a wearable heads-up display 100a with a laser projector 120 and a transparent combiner 111 in a field of view of an eye 170 of a user in accordance with the present systems, devices, and methods. WHUD 100a includes a support structure, with the general shape and appearance of an eyeglasses frame, carrying an eyeglass lens 110 with a transparent combiner 111, and a laser projector 120. Laser projector 120 includes laser diodes 131, 132, and 133, a beam combiner 140 including optical elements 141, 142, and 143, and a controllable mirror 160.

Throughout this specification and the appended claims, the term “carries” and variants such as “carried by” or “carrying” are generally used to refer to a physical coupling between two objects. The physical coupling may be direct physical coupling (i.e., with direct physical contact between the two objects) or indirect physical coupling mediated by one or more additional objects. Thus, the term carries and variants such as “carried by” are meant to generally encompass all manner of direct and indirect physical coupling.

Exemplary wearable heads-up display 100a operates as follows. Laser diodes 131, 132, and 133 of laser projector 120 generate laser light (shown as solid arrows). In other embodiments, the number, type, and output wavelength of light sources may be different. In exemplary WHUD 100a, laser diode 131 is a red laser diode that generates red laser light, laser diode 132 is a green laser diode that generates green laser light, and laser diode 133 is a blue laser diode that generates blue laser light. The output of light from the laser diodes may be modulated via signals produced by a processor (e.g., microprocessor, field programmable gate array, application specific integrated circuit, programmable logic controller or other hardware circuitry), and the processor may be communicatively coupled to a non-transitory processor-readable storage medium (e.g., volatile memory such as Random Access Memory (RAM), memory caches, processor registers; nonvolatile memory such as Read Only Memory, EEPROM, Flash memory, magnetic disks, optical disks) that stores processor-executable data and/or instructions. The red laser light, green laser light, and blue laser light are directed towards beam combiner 140. Beam combiner 140 includes three optical elements 141, 142, and 143. The red laser light is directed towards optical element 141. Optical element 141 is a mirror that reflects the red laser light towards optical element 142. The green laser light is directed towards optical element 142. Optical element 142 is a dichroic mirror that is transmissive of the red laser light and reflective of the green laser light. The red laser light and green laser light are combined by optical element 142 and directed towards optical element 143. The blue laser light is directed towards optical element 143. Optical element 142 is a dichroic mirror that is transmissive of the blue laser light and reflective of the red laser light and the green laser light. Optical element 143 combines the red laser light, the green laser light, and the blue laser light into an aggregate beam 150 and directs aggregate beam 150 towards controllable mirror 160.

Controllable mirror 160 scans the laser light onto transparent combiner 111 carried on eyeglass lens 110. Controllable mirror 160 may be a bi-axial mirror that directly scans the laser light onto transparent combiner 111. Alternatively, controllable mirror 160 may be a first mirror in a set of two mirrors, wherein the first mirror scans the laser light along a single axis (e.g., horizontal axis) towards a second mirror which scans the light on an orthogonal axis (e.g., vertical axis) towards transparent combiner 111. Transparent combiner 111 “combines” the environmental light and the laser light from the laser projector in the field of view of eye 170 of the user. Transparent combiner 111 may include a holographic optical element. Transparent combiner 111 redirects aggregate beam 150, scanned from controllable mirror 160, towards eye 170 of the user. Aggregate beam 150 converges to a point in front of transparent combiner 111 and is diverging at transparent combiner 111. Transparent combiner 111 at least approximately collimates the laser light and redirects it towards eye 170 of the user, such that the laser spot at transparent combiner 111 is approximately the same shape and size as the laser spot at a cornea of eye 170. Eye 170 converges the light towards a retina of eye 170 (shown as the back of eye 170). In FIG. 1A, aggregate beam 150 maintains a single focal length while being scanned onto transparent combiner 111. However, due to the shape of transparent combiner 111 and the location of laser projector 120 with respect to transparent combiner 111, a single focal length is not appropriate for light scanned to all areas of transparent combiner 111. Two scanned locations of aggregate beam 150 are shown. Arrows 151a and 151b represent aggregate beam 150 scanned to a first location and arrows 152a and 152b represent aggregate beam 150 scanned to a second location. Arrows 151a and 151b converge and then diverge at transparent combiner 111 such that the laser light converges at the retina of eye 170. A person of skill in the art will appreciate that the position of the laser projector in relation to the transparent combiner may result in the laser light having a focal length that will not converge to a focused spot at any location on the retina. The second scanned location is farther from controllable mirror 160 than the first location, therefore, arrows 152a and 152b converge and then diverge to a greater extent than arrows 151a and 151b. This results in a larger collimated beam being directed towards eye 170. This larger beam cannot converge to a focused spot on the retina by eye 170. Any point on transparent combiner 111 that is farther or closer than the point of incidence shown by arrows 151a and 151b will result in an unfocused spot on the retina. The resulting image seen by the user would be focused only where light has been redirected from a location at the optimal point of incidence (e.g., the first scanned location) and unfocused where light has come from a location at an incorrect distance (e.g., the second scanned location).

FIG. 1B is a schematic diagram of an operation of a wearable heads-up display 100b with a laser projector 120, a field shaper optic 180, and a transparent combiner 111 in a field of view of an eye 170 of a user in accordance with the present systems, devices, and methods. WHUD 100b is generally similar to WHUD 100a and includes a support structure, with the general shape and appearance of an eyeglasses frame, carrying an eyeglass lens 110 with a transparent combiner 111, and laser projector 120. Laser projector 120 includes laser diodes 131, 132, and 133, a beam combiner 140 including optical elements 141, 142, and 143, and a controllable mirror 160. WHUD 100b further includes field shaper optic 180 in the optical path of the laser light between controllable mirror 160 and transparent combiner 111. Exemplary wearable heads-up display 100b operates as follows. Laser diodes 131, 132, and 133 of laser projector 120 generate laser light (shown as solid arrows). In exemplary WHUD 100, laser diode 131 is a red laser diode that generates red laser light, laser diode 132 is a green laser diode that generates green laser light, and laser diode 133 is a blue laser diode that generates blue laser light. The output of light from the laser diodes may be modulated by a processor, and the processor may be communicatively coupled to a non-transitory processor-readable storage medium that stores processor-executable data and/or instructions. The red laser light, green laser light, and blue laser light are directed towards beam combiner 140. Beam combiner 140 includes three optical elements 141, 142, and 143. The red laser light is directed towards optical element 141. Optical element 141 is a mirror that reflects the red laser light towards optical element 142. The green laser light is directed towards optical element 142. Optical element 142 is a dichroic mirror that is transmissive of the red laser light and reflective of the green laser light. The red laser light and green laser light are combined by optical element 142 and directed towards optical element 143. The blue laser light is directed towards optical element 143. Optical element 142 is a dichroic mirror that is transmissive of the blue laser light and reflective of the red laser light and the green laser light. Optical element 143 combines the red laser light, the green laser light, and the blue laser light into an aggregate beam 150 and directs aggregate beam 150 towards controllable mirror 160.

Controllable mirror 160 scans the laser light onto transparent combiner 111 carried on eyeglass lens 110. Controllable mirror 160 may be a bi-axial mirror that directly scans the laser light onto transparent combiner 111. Alternatively, controllable mirror 160 may be a first mirror in a set of two, wherein the first mirror scans the laser light along a single axis (e.g., horizontal axis) towards a second mirror which scans the light on an orthogonal axis (e.g., vertical axis) towards transparent combiner 111. Transparent combiner 111 may include a holographic optical element. Transparent combiner 111 redirects aggregate beam 150, scanned from controllable mirror 160, towards eye 170 of the user. Aggregate beam 150 converges to a focal point in front of transparent combiner 111 and is diverging at transparent combiner 111. Transparent combiner 111 at least approximately collimates the laser light and redirects it towards eye 170 of the user, such that the laser spot at transparent combiner 111 is approximately the same shape and size as the laser spot at a cornea of eye 170. Eye 170 converges the light towards a retina of eye 170 (shown as the back of eye 170). In FIG. 1B, the focal length of scanned aggregate beam 150 is heterogeneously varied as the light passes through field shaper optic 180. Field shaper optic 180 is oriented, and positioned to heterogeneously vary the focal length of scanned aggregate beam 150 to have an at least approximately uniform laser spot over the scanned area of transparent combiner 111. That is, laser light passing through any point of field shaper optic 180 exits field shaper optic 180 with the correct focal length to be redirected by transparent combiner 111 to eye 170 and create a focused image at the retina of eye 170. The laser spot scanned over transparent combiner 111 must approximate uniformity, in both shape and size, at least closely enough to result in a uniformity of laser spot at the retina that creates an in-focus image with uniform resolution. A measure of this uniformity may be the pixels per degree (ppd) of the image on the retina. For example, if 10.0 ppd with a margin of error of +/−1.0 ppd is desired at the retina, the size of laser spot scanned at any given point over the transparent combiner can be no larger than a size that would result in 9.0 ppd and no smaller than a size that would result in 11.0 ppd. Therefore, field shaper optic 180 must vary the laser light to only have focal lengths that create laser spots on transparent combiner 111 that result in 10.0 (+/−1.0) ppd at the retina. Transparent combiner 111 may have a curved surface necessitating the creation of a matching curved field of laser light by field shaper optic 180. Field shaper optic 180 may be a freeform lens having a shape dependent on the shape of transparent combiner 111 and dependent on the location of field shaper optic 180 within the wearable heads-up display in relation to laser projector 120 and transparent combiner 111. Alternatively, field shaper optic 180 may have an anamorphic aspherical shape. The optical function that field shaper optic 180 applies to the laser light may be dependent on one or more properties of the laser light including: a point of incidence of the laser light on field shaper optic 180, an angle of incidence of the laser light on field shaper optic 180, a spot size of the laser light on field shaper optic 180, and a spot shape of the laser light on field shaper optic 180.

Two scanned locations of aggregate beam 150 are shown. Arrows 151a and 151b represent aggregate beam 150 scanned to a first location (identical to the first location in FIG. 1A) and arrows 152a and 152b represent aggregate beam 150 scanned to a second location (identical to the second location in FIG. 1A). Subsequent connected arrows are not marked to reduce clutter. Arrows 151a and 151b converge and then diverge at transparent combiner 111 such that the laser light converges at the retina of eye 170. Although arrows 151a and 151b pass through field shaper optic 180, the optical power of field shaper optic 180 at that location negligibly affects the light. However, a person of skill in the art will appreciate that in other embodiments the focal length of all of the laser light may be varied by field shaper optic 180. The second scanned location is farther from controllable mirror 160 than the first location, and in the absence of field shaper optic 180 arrows 152a and 152b would not focus on the retina as in FIG. 1A. In FIG. 1B, however, the optical power of field shaper optic 180 at the location of incidence of arrows 152a and 152b alters the focal length of aggregate beam 150. This altered focal length is represented by arrows 152c and 152d which converge and then diverge at transparent combiner 111 such that the laser light subsequently converges at the retina of eye 170. With field shaper optic 180, any point on transparent combiner, regardless of the distance from controllable mirror 160, redirects laser light that focuses at the retina. The image seen by the user is focused.

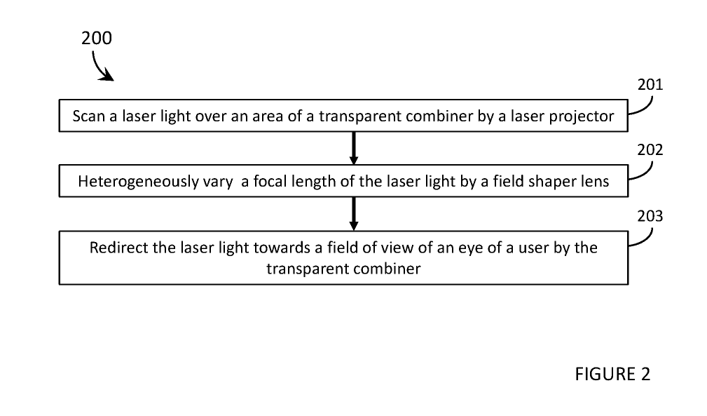

FIG. 2 is a flow diagram of a method 200 of operating a wearable heads-up display with a laser projector and a field shaper optic in accordance with the present systems, devices, and methods. The WHUD of FIG. 2 may be substantially similar to WHUD 100b of FIG. 1B and generally includes a support structure carrying: a laser projector with a field shaper optic and a transparent combiner. Method 200 includes acts 201, 202, and 203, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 201, laser light is scanned over an area of the transparent combiner by the laser projector. The laser projector may generate light by at least one laser diode. In an implementation with multiple laser diodes, a beam combiner may be used to create an aggregate beam from the multiple laser beams. The laser projector may include at least one controllable mirror to scan the laser light over an area of the transparent combiner.

At 202, the field shaper optic heterogeneously varies the focal length of the laser light. The field of the laser light is shaped before incidence on the transparent combiner to achieve an at least approximately uniform laser spot over the area of the transparent combiner, the laser spot being of a size that creates a focused image on a retina of an eye of a user. The transparent combiner may include a curved surface and the field shaper optic may heterogeneously vary the focal length of the laser light field to match the curved shape of the transparent combiner. The focal length of the laser light may be varied to have the focal points of the laser light, and therefore the field, at the transparent combiner, or to have the focal points of the laser light at approximately a uniform distance from the transparent combiner. The optical function that the field shaper optic applies to the laser light may be dependent on one or more properties of the laser light including: the point of incidence of the laser light on the field shaper optic, the angle of incidence of the laser light on the field shaper optic, a spot size of the laser light on the field shaper optic, and a spot shape of the laser light on the field shaper optic.

At 203, the transparent combiner redirects the laser light towards a field of view of the eye of the user. The transparent combiner may include at least one holographic optical element, and the holographic optical element may at least approximately collimate the laser light to provide a laser spot at the eye that approximates the size and shape of the laser spot at the transparent combiner. Properly-sized and uniform laser spots at the transparent combiner and subsequently the cornea of the eye result in the eye of the user converging the laser light to create a focused image at the retina.

In some implementations, the laser projector may scan laser light over more than one area of the transparent combiner. The areas may overlap or be spatially distinct. The field shaper optic may shape an overall field which encompasses all of the areas or may shape areas individually.

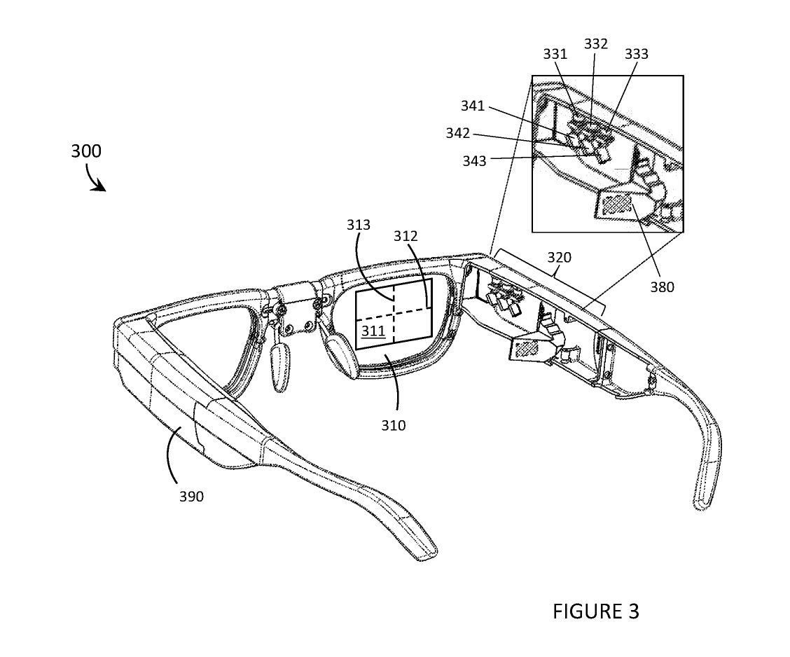

FIG. 3 is an isometric view of a wearable heads-up display 300 with a laser projector 320 and a field shaper optic 380 in accordance with the present systems, devices, and methods. WHUD 300 includes a support structure 390 that in use is worn on the head of the user and has a general shape and appearance of an eyeglasses frame. Support structure 390 carries multiple components, including an eyeglass lens 310, a transparent combiner 311, laser projector 320, and field shaper optic 380. Laser projector 320 includes (blow-out) laser diodes 331, 332, and 333, and a beam combiner. The beam combiner includes optical elements 341, 342, and 343. WHUD 300 operates in generally the same manner as WHUD 100b from FIG. 1B.

Laser diodes 331, 332, and 333 generate laser light. As in FIGS. 1A and 1B, red laser diode 331 generates red laser light, green laser diode 332 generates green laser light, and blue laser diode 333 generates blue laser light. The red laser light is directed towards optical element 341, a mirror, which reflects the red laser light towards optical element 341. The green laser light is directed towards optical element 342. Optical element 342 is a dichroic mirror that is transmissive to the red laser light and reflective of the green laser light and directs red and green laser light towards optical element 343. The blue laser light is directed towards optical element 343. Optical element 343 is a dichroic mirror that is transmissive to the blue laser light and reflective of the red laser light and the green laser light. Optical element 343 combines the red laser light, green laser light, and blue laser light into an aggregate beam that is directed towards at least one controllable mirror (not shown). The at least one controllable mirror scans the aggregate beam through field shaper optic 380 and onto transparent combiner 311. Transparent combiner 311 has a center horizontal axis 312 (dashed line), and a center vertical axis 313 (dashed line). Laser projector 320 is located off-axis, and projects light from a location that is off-axis, with respect to both center horizontal axis 312 and center vertical axis 313. A person of skill in the art will appreciate that the laser projector may be located off-axis with respect to either or both of the center axes. Field shaper optic 380 heterogeneously varies the focal length of the aggregate beam as it is scanned therethrough to result in an at least approximately uniform laser spot (in shape and size) at transparent combiner 311. The size and shape of the at least approximately uniform laser spot is the size and shape that results in the convergence of laser light at a retina of an eye of a user for the specific architecture of the wearable heads-up display. Additional optical elements that affect the laser light may be in the optical path of the laser light between field shaper optic 380 and transparent combiner 311. Field shaper optic 380 may be shaped, oriented, and positioned to heterogeneously vary the focal length of the laser light to result in an at least approximately uniform laser spot at transparent combiner 311 when the laser light also passes through these additional optical elements. Laser projector 320 may scan light onto transparent combiner 311 from an off-axis location (with respect to central axis of transparent combiner 311), necessitating a freeform, asymmetrically-shaped field shaper optic 380. Alternatively field shaper optic 380 may have an anamorphic aspherical shape. Transparent combiner 311 may be a curved surface and field shaper optic 380 may shape the field of laser light to at least approximately match the curved shape of transparent combiner 311. Field shaper optic 380 may heterogeneously vary the focal length of the laser light such that the focal points of the laser light are located at the surface of transparent combiner 311 or are located at a uniform distance from transparent combiner 311. The optical function applied to the laser light by field shaper optic 380 may be dependent on at least one property of the laser light, including: a location of incidence of the laser light on field shaper optic 380, an angle of incidence of the laser light on field shaper optic 380, a spot size of the laser light on field shaper optic 380, and a spot shape of the laser light on field shaper optic 380.

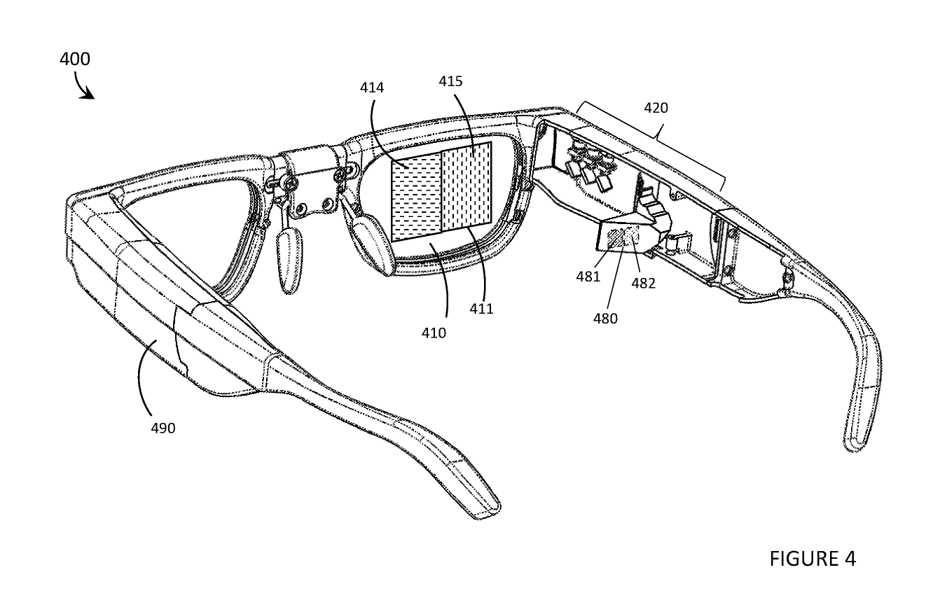

FIG. 4 is an isometric view of a wearable heads-up display 400 with a laser projector 420 and a field shaper optic 480 which shapes two separate fields in accordance with the present systems, devices, and methods. In some WHUD implementations it may be advantageous to employ multiple exit pupils to provide a larger eyebox to the user. Examples of such systems, devices, and methods can are described in: US Patent Application Publication No. US 2016-0377866 A1, US Patent Application Publication No. US 2016-0377865 A1, and US Patent Application No. US 2016-0238845 A1. In such implementations, distinct areas of the transparent combiner may represent different exit pupils of laser light which require individual field shaping. These distinct areas of the transparent combiner may overlap or may be spatially-separated. WHUD 400 is an example of such a WHUD. WHUD 400 includes a support structure 490 that in use is worn on the head of the user and has a shape and appearance of an eyeglasses frame. Support structure 490 carries multiple components, including an eyeglass lens 410, a transparent combiner 411, laser projector 420, and field shaper optics 480. WHUD 400 operates as follows.

Laser projector 420 operates in a similar manner to laser projector 320 with multiple laser diodes generating laser light which is combined in a beam combiner and then scanned by a controllable mirror onto and through field shaper optic 480. Laser projector 420 includes means to project two sets of scanned laser light which represent a first exit pupil and a second exit pupil (e.g., systems, devices, and methods as described in the above referenced US patent application Publications). Field shaper optic 480 includes two distinct facets (or regions) 481 and 482. The set of scanned laser light representing the first exit pupil is incident on field shaper optic facet 481 and the set of scanned laser light representing the second exit pupil is incident on field shaper optic facet 482. Field shaper optic facet 481 heterogeneously varies the focal length of the aggregate beam of the first set of laser light as it is scanned therethrough to result in an at least approximately uniform laser spot (in shape and size) at a first region 414 of transparent combiner 411. Field shaper optic facet 482 heterogeneously varies the focal length of the aggregate beam of the second set of laser light as it is scanned therethrough to result in an at least approximately uniform laser spot (in shape and size) at a second region 415 of transparent combiner 411. The laser spot shape and size should be at least approximately uniform across all regions of the transparent combiner. As in FIGS. 1B, and 3, laser projector 420 may scan light onto regions 414 and 415 of transparent combiner 411 from an off-axis location (with respect to the central axes of transparent combiner 411). Therefore, one or both of field shaper optic facet 481 and field shaper optic facet 482 may both require a freeform, asymmetrical shape. Alternatively, one or both of field shaper optic facet 481 and field shaper optic facet 482 may both have an anamorphic aspherical shape. In other implementations, n (where n is any integer greater than 1) exit pupils may employed, necessitating a field shaper optic with n facets (or regions), wherein each facet may have a freeform asymmetric shape or an anamorphic aspherical shape.

A person of skill in the art will appreciate that the various embodiments for minimizing image distortion described herein may be applied in non-WHUD applications. For example, the present systems, devices, and methods may be applied in non-wearable heads-up displays and/or in other applications that may or may not include a visible display.

In some implementations, one or more optical fiber(s) may be used to guide light signals along some of the paths illustrated herein.

The WHUDs described herein may include one or more sensor(s) (e.g., microphone, camera, thermometer, compass, altimeter, and/or others) for collecting data from the user's environment. For example, one or more camera(s) may be used to provide feedback to the processor of the WHUD and influence where on the display(s) any given image should be displayed.

The WHUDs described herein may include one or more on-board power sources (e.g., one or more battery(ies)), a wireless transceiver for sending/receiving wireless communications, and/or a tethered connector port for coupling to a computer and/or charging the one or more on-board power source(s).

The WHUDs described herein may receive and respond to commands from the user in one or more of a variety of ways, including without limitation: voice commands through a microphone; touch commands through buttons, switches, or a touch sensitive surface; and/or gesture-based commands through gesture detection systems as described in, for example, U.S. Non-Provisional patent application Ser. No. 14/155,087, U.S. Non-Provisional patent application Ser. No. 14/155,107, PCT Patent Application PCT/US2014/057029, and/or U.S. Provisional Patent Application Ser. No. 62/236,060, all of which are incorporated by reference herein in their entirety.

Throughout this specification and the appended claims, the term “processor” is often used. Generally, “processor” refers to hardware circuitry, in particular any of microprocessors, microcontrollers, application specific integrated circuits (ASICs), digital signal processors (DSPs), programmable gate arrays (PGAs), and/or programmable logic controllers (PLCs), or any other integrated or non-integrated circuit that perform logic operations.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), and/or optical pathways (e.g., optical fiber), and exemplary communicative couplings include, but are not limited to, electrical couplings, magnetic couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including but not limited to: US Patent Application Publication No. US 2015-0378161 A1, US Patent Application Publication No. US 2016-0377866 A1, US Patent Application Publication No. US 2016-0377865 A1, US Patent Application Publication No. US 2016-0238845 A1, U.S. Non-Provisional patent application Ser. No. 15/046,234, U.S. Non-Provisional patent application Ser. No. 15/046,254, US Patent Application Publication No. US 2016-0238845 A1, U.S. Non-Provisional patent application Ser. No. 15/145,576, U.S. Non-Provisional patent application Ser. No. 15/145,609, U.S. Non-Provisional patent application Ser. No. 15/145,583, U.S. Non-Provisional patent application Ser. No. 15/256,148, U.S. Non-Provisional patent application Ser. No. 15/167,458, U.S. Non-Provisional patent application Ser. No. 15/167,472, U.S. Non-Provisional patent application Ser. No. 15/167,484, U.S. Provisional Patent Application Ser. No. 62/271,135, U.S. Non-Provisional patent application Ser. No. 15/331,204, US Patent Application Publication No. US 2014-0198034 A1, US Patent Application Publication No. US 2014-0198035 A1, U.S. Non-Provisional patent application Ser. No. 15/282,535, U.S. Provisional Patent Application Ser. No. 62/268,892, U.S. Provisional Patent Application Ser. No. 62/322,128, U.S. Provisional Patent Application Ser. No. 62/420,368, U.S. Provisional Patent Application Ser. No. 62/420,371, and U.S. Provisional Patent Application Ser. No. 62/420,380 are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable heads-up display (“WHUD”) comprising:
a support structure that in use is worn on a head of a user;
a transparent combiner carried by the support structure, wherein the transparent combiner is positioned within a field of view of an eye of the user when the support structure is worn on the head of the user;
a laser projector carried by the support structure, the laser projector including at least one laser diode to generate laser light, wherein the laser projector is positioned and oriented to scan laser light over at least a first area of the transparent combiner, and wherein laser light output by the laser projector has a focal length; and
a field shaper optic positioned in between the at least one laser diode and the transparent combiner in an optical path of the laser light, the field shaper optic to heterogeneously vary the focal length of the laser light to provide an at least approximately uniform laser spot over the first area of the transparent combiner.

2. The WHUD of claim 1 wherein the support structure has the shape and appearance of an eyeglasses frame and the transparent combiner includes an eyeglass lens.

3. The WHUD of claim 1 wherein the transparent combiner includes at least one holographic optical element positioned to redirect the laser light towards the eye of the user.

4. The WHUD of claim 3 wherein upon redirection of the laser light towards the eye of the user, the holographic optical element at least approximately collimates the laser light to provide a laser spot at the eye of the user having both a size and a shape that at least approximately match the size and the shape of the laser spot at the transparent combiner.

5. The WHUD of claim 1 wherein the laser projector includes:
at least one controllable mirror positioned to receive laser light from the laser diode and controllably orientable to scan the laser light over the at least a first area of the transparent combiner.

6. The WHUD of claim 5 wherein the field shaper optic is positioned in between the at least one controllable mirror and the transparent combiner in the optical path of the laser light.

7. The WHUD of claim 5 wherein the laser projector further comprises:
a beam combiner positioned in the optical path of the laser light in between the at least one laser diode and the controllable mirror, wherein the at least one laser diode includes a red laser diode, a green laser diode, and a blue laser diode, and wherein the beam combiner is oriented to combine red laser light from the red laser diode, green laser light from the green laser diode, and blue laser light from the blue laser diode into an aggregate laser beam.

8. The WHUD of claim 1 wherein the field shaper optic is a freeform lens having a shape dependent on both a shape of the transparent combiner and a position of the laser projector in relation to the transparent combiner.

9. The WHUD of claim 1 wherein the field shaper optic is an anamorphic asphere having a shape dependent on both a shape of the transparent combiner and a position of the laser projector in relation to the transparent combiner.

10. The WHUD of claim 1 wherein the transparent combiner has a center horizontal axis and a center vertical axis and a position of the laser projector is off-axis relative to at least one of the center horizontal axis and the center vertical axis of the transparent combiner.

11. The WHUD of claim 1 wherein the field shaper optic heterogeneously varies the focal length of the laser light to provide a laser light field having a shape that at least approximately matches a shape of a surface of the transparent combiner.

12. The WHUD of claim 11 wherein the transparent combiner includes a curved surface and the field shaper optic heterogeneously varies the focal length of the laser light to provide a curved laser light field having a curvature that at least approximately matches a curvature of the curved surface of the transparent combiner.

13. The WHUD of claim 1 wherein the field shaper optic heterogeneously varies the focal length of the laser light to achieve an approximately uniform distance of the laser light focal point from the transparent combiner.

14. The WHUD of claim 1 wherein to heterogeneously vary the focal length of the laser light the field shaper optic applies a particular optical function thereto dependent on at least one property of the laser light selected from a group consisting of: a point of incidence of the laser light on the field shaper optic, an angle of incidence of the laser light on the field shaper optic, a spot size of the laser light on the field shaper optic, and a spot shape of the laser light on the field shaper optic.

15. The WHUD of claim 1 wherein the laser projector is positioned and oriented to scan laser light over at least a second area of the transparent combiner, and wherein the field shaper optic heterogeneously varies the focal length of the laser light to provide an at least approximately uniform laser spot over the first area and the second area of the transparent combiner.

16. The WHUD of claim 15 wherein the field shaper optic is a freeform lens having a shape dependent on both a shape of the transparent combiner and a position of the laser projector in relation to the first area of the transparent combiner and the second area of the transparent combiner.

17. The WHUD of claim 15 wherein the fields shaper lens includes a first anamorphic asphere and a second anamorphic asphere, wherein the first anamorphic asphere heterogeneously varies the focal length of the laser light to provide an at least approximately uniform laser spot over the first area of the transparent combiner and the second anamorphic asphere heterogeneously varies the focal length of the laser light to provide an at least approximately uniform laser spot over the second area of the transparent combiner, and wherein the shape of the first anamorphic asphere is dependent on both a shape of the transparent combiner and a position of the laser projector in relation to the first area of the transparent combiner, and wherein the shape of the second anamorphic asphere is dependent on both a shape of the transparent combiner and a position of the laser projector in relation to the second area of the transparent combiner.
